(19) United States
(12) Patent Application Publication
(10) Pub. No.: US 2013/0279758 A1
(43) Pub. Date: Oct. 24, 2013

(54) METHOD AND SYSTEM FOR ROBUST TILT ADJUSTMENT AND CROPPING OF LICENSE PLATE IMAGES

(71) Applicants: Aaron Michael Burry, Ontario, NY (US); Claude Fillion, Rochester, NY (US); Vladimir Kozitsky, Rochester, NY (US); Zhigang Fan, Webster, NY (US)

(72) Inventors: Aaron Michael Burry, Ontario, NY (US); Claude Fillion, Rochester, NY (US); Vladimir Kozitsky, Rochester, NY (US); Zhigang Fan, Webster, NY (US)

(73) Assignee: XEROX CORPORATION, Norwalk, CT (US)

(21) Appl. No.: 13/453,144

(22) Filed: Apr. 23, 2012

(51) Int. Cl. G06K 9/46; G06K 9/00

(52) U.S. Cl. 382/105; 382/195

(57) ABSTRACT

Methods, systems and processor-readable media for robust tilt adjustment and cropping of a license plate image. A vehicle image can be captured by an image-capturing unit and converted to a binary image utilizing a binarization approach. A long run within the binary image can then be removed and a morphological filtering can be applied to break an unwanted connection between characters due to a license plate frame and an image noise. A connected component (CC) within the image can be identified and screened based on a number of key metrics to remove a most likely candidate character connected component. A line-fit based iterative search process can then be performed for robust tilt removal and vertical cropping of the license plate image to obtain a tight bounding box on the license plate characters if sufficient candidate characters remain after the search process. Otherwise, the region of interest can be rejected.

### TECHNICAL HELD

Embodiments are generally related to data-processing systems. Embodiments are also related to ALPR (Automatic License Plate Recognition) techniques, methods, and systems. Embodiments are additionally related to image-processing methods and systems.

### BACKGROUND OF THE INVENTION

ALPR (Automatic License Plate Recognition) systems often function as the core module of “intelligent” transportation infrastructure applications. License plate recognition can be employed to identify a vehicle by automatically reading a license plate utilizing an image-processing and character recognition technology. A license plate recognition operation can be performed by locating the license plate in an image, segmenting the characters in the plate, and performing an OCR (Optical Character Recognition) operation with respect to the characters identified.

A sub-if mage (e.g., tight bounding box image) containing tightly cropped license plate characters with any tilt of the plate in an original image removed must be obtained as part of the plate localization and segmentation process in preparation for OCR. Accurately extracting the tight bounding box image helps ensure that clean character sub-images can be extracted and sent to OCR for high accuracy recognition.

Unfortunately, the license plate images captured under a realistic condition (i.e., field deployed solutions) includes a number of noise sources such as, for example, heavy shadows, non-uniform illumination (from one vehicle to next, daytime versus nighttime, etc.), challenging optical geometries (tilt, shear, or projective distortions), plate frames and/or stickers partially touching characters, partial occlusion of characters (e.g., trailer hitch ball), poor contrast, and general image noise (e.g., salt and pepper noise). Such errors and inconsistencies can severely degrade the subsequent segmentation and OCR performance. As a result, the plate localization step typically produces a candidate region of interest (ROI) sub-images which likely contain license plates within them. In other words, standard approaches for plate localization do not typically produce tightly cropped candidate ROI images.

Several approaches have been implemented for performing character segmentation on the license plate images. The accuracy of the segmentation can be greatly improved if the tilt of the license plate in the image has been removed and the tight bounding box around the characters has been obtained. One approach involves the use of a projective segmentation for identifying a cropping boundary for both the tight bounding box around the license plate and the characters sub-images. Unfortunately, such approach is most effective if the license plate tilt has already been removed. Also, prior art approaches for removing the license plate tilt from the input image does not provide a high accuracy performance of the overall system and is not robust to both real world noise factors present in the license plate images and to inaccuracy in the cropping results of the plate localization step.

Based on the foregoing, it is believed that a need exists for an improved method and system for robust tilt adjustment and cropping of the license plate images, as will be described in greater detail herein.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for improved ALPR (Automatic License Plate Recognition) methods and systems.

It is another aspect of the disclosed embodiments to provide for an improved method and system for robust tilt adjustment and cropping of a license plate image.

The aforementioned aspects and other objectives and advantages can now be achieved as described herein. A method and system for robust tilt adjustment and cropping of a license plate image is disclosed herein. A vehicle image can be captured by an image-capturing unit and the image (typically gray for infrared captures) can be converted to a binary image utilizing a binarization approach (e.g., a gradient based binarization). A long run (horizontal sequences of “on” pixels that exceed a predefined length) within the binary image can then be removed and a morphological filtering can be applied to break an unwanted connection between characters due to a license plate frame and an image noise. A connected component (CC) within the image can be identified and screened based on a number of key metrics to remove all but the most likely candidate character connected components. A line-fit based iterative search process can then be performed for robust tilt removal and vertical cropping of the license plate image to obtain a tight bounding box on the license plate characters if sufficient candidate characters remain after the search process. Otherwise, the region of interest can be rejected.

The candidate characters can be pruned based on the connected component area and angle of orientation of a connected component blob. The candidate characters can be substantially vertical within the input image to eliminate a large fraction of connected components due to a plate frame, an artifact from stickers around the plate, a rear emblem on vehicle, and noise from the binarization approach. A best-fit straight line for the subset of the candidate character connected components can be determined so that the license plate characters can lie along a straight-line path. A straight-fine through the connected component center data can be fit and a total sum squared error in the fit can be calculated. If the total sum squared error is larger than a pre-determined threshold, a residual error for each data point can be calculated and the connected component with a largest error contribution can be excluded. This process can then be repeated until a better set of candidate connected components for which the straight-line fit through their centers can be found and/or the connected components are not sufficient to continue the process.

An additional screening wherein the connected components are grouped according to a vertical coordinate value can be applied and a largest group can be retained prior to starting the iterative loop. If sufficient candidate characters remain, then the straight line fit through the centers can be employed to estimate a tilt angle θ of the license plate. After removing this tilt in the image by rotating by −θ, a median height of the candidate character connected components can be utilized to determine the required vertical cropping to obtain the tight bounding box on the license plate characters. A mean filtering, or leveraging additional screening of the candidate characters utilizing a priori information (e.g., expected character height ranges) can be employed. A fixed border allowance beyond the median height can also be applied to ensure that characters are not accidentally cropped even for extreme cases and to obtain a properly oriented license plate image that has been vertically cropped. The sequence of connected component analysis and screening operations removes any inherent tilt and provides a vertically cropped license plate image even for cases of extremely coarse plate localization and large amounts of non-character image content present in the image.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system, in accordance the disclosed embodiments;

FIG. 2 illustrates a schematic view of a software system including a license plate tilt adjustment and cropping module, an operating system, and a user interface, in accordance with the disclosed embodiments;

FIG. 3 illustrates a block diagram of a license plate tilt adjustment and cropping system, in accordance with the disclosed embodiments;

FIG. 4 illustrates a block diagram of an ALPR method, in accordance with the disclosed embodiments;

FIG. 5 illustrates a pictorial view of tilt removal and tight bounding box extraction with respect to a license plate image, in accordance with the disclosed embodiments;

FIG. 6 illustrates a high level flow chart of operations illustrating logical operational steps of a method for robust tilt adjustment and cropping of a license plate image, in accordance with the disclosed embodiments;

FIG. 7 illustrates a high level flow chart of operations illustrating logical operational steps of a line-fit based iterative searching method, in accordance with the disclosed embodiments;

FIGS. 8-9 illustrate an exemplary view of an original grayscale image and a binary image after morphological filtering, in accordance with the disclosed embodiments;

FIGS. 10-11 illustrate an exemplary view of an image screened based on a connected component area and an angle of orientation of the connected component blob, in accordance with the disclosed embodiments;

FIGS. 12-13 illustrate a graph depicting a center of connected component after angle screening and a weighted least square line fit, in accordance with the disclosed embodiments;

FIG. 14 illustrates an exemplary view of an image after tilt removal based on the weighted least square line fit of the connected component center data, in accordance with the disclosed embodiments;

FIG. 15 illustrates an exemplary view of an image after screening connected components by vertical separation and line fitting, in accordance with the disclosed embodiments;

FIG. 16 illustrates an exemplary view of an ROI image after tilt removal, in accordance with the disclosed embodiments; and

FIG. 17 illustrates an exemplary view of the image after tilt removal and vertical cropping, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the present invention can be embodied as a method, data processing system, or computer program product. Accordingly, the present invention may take the form of an entire hardware embodiment, an entire software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, USB flash drives, DVDs, CD-ROMs, optical storage devices, magnetic storage devices, etc.

Computer program code for carrying out operations of the present invention may be written in an object oriented programming language (e.g., JAVA, C++, etc.). The computer program code, however, for carrying out operations of the present invention may also be written in conventional procedural programming languages such as the “C” programming language or in a visually oriented programming environment such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, WiMax, 802.11x, and cellular network or the connection can be made to an external computer via most third party supported networks (e.g., through the Internet via an Internet service provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

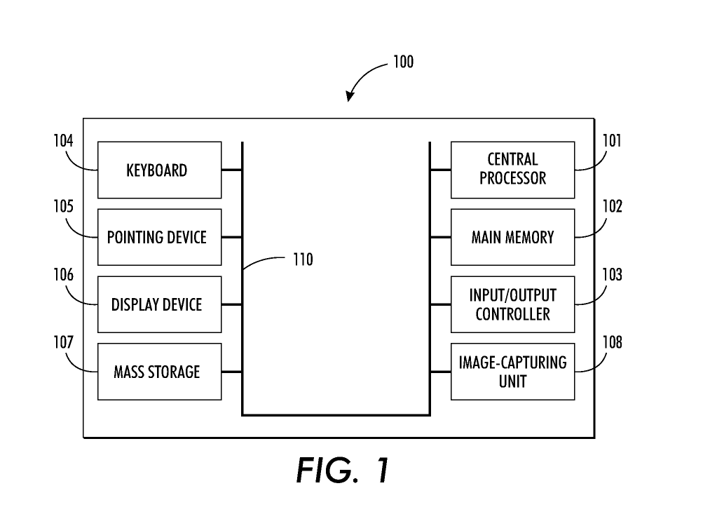

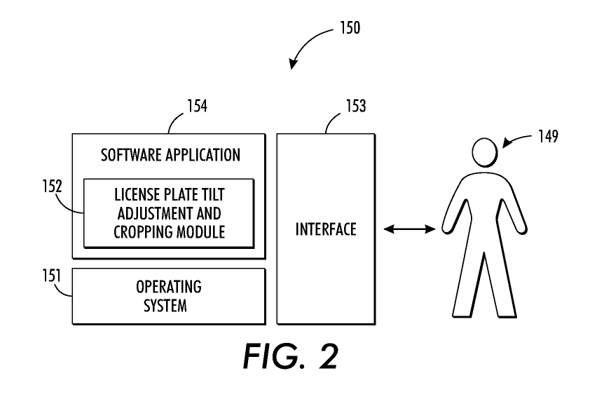

FIGS. 1-2 are provided as exemplary diagrams of data-processing environments in which embodiments of the present invention may be implemented. It should be appreciated that FIGS. 1-2 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 1, the disclosed embodiments may be implemented in the context of a data-processing system 100 that includes, for example, a central processor 101, a main memory 102, an input/output controller 103, a keyboard 104, an input device 105 (e.g., a pointing device such as a mouse, track ball, pen device, etc.), a display device 106, a mass storage 107 (e.g., a hard disk), and an image capturing unit 108. As illustrated, the various components of data-processing system 100 can communicate electronically through a system bus 110 or similar architecture. The system bus 110 may be, for example, a subsystem that transfers data between, for example, computer components within data-processing system 100 or to and from other data-processing devices, components, computers, etc.

FIG. 2 illustrates a computer software system 150 for directing the operation of the data-processing system 100 depicted in FIG. 1. Software application 154, stored in main memory 102 and on mass storage 107, generally includes a kernel or operating system 151 and a shell or interface 153. One or more application programs, such as software application 154, may be “loaded” (i.e., transferred from mass storage 107 into the main memory 102) for execution by the data-processing system 100. The data processing system 100 receives user commands and data through user interface 153; these inputs may then be acted upon by the data-processing system 100 in accordance with instructions from operating system module 151 and/or software application 154.

The following discussion is intended to provide a brief, general description of suitable computing environments in which the system and method may be implemented. Although not required, the disclosed embodiments will be described in the general context of computer-executable instructions such as program modules being executed by a single computer. In most instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked personal computers, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application such as a computer program designed to assist in the performance of a specific task such as word processing, accounting, inventory management, etc.

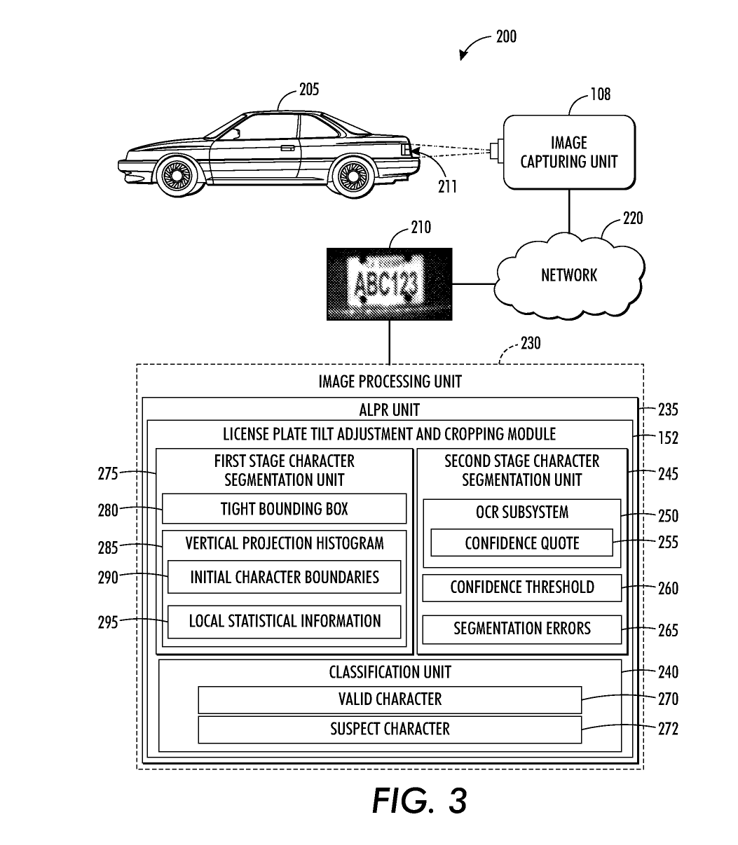

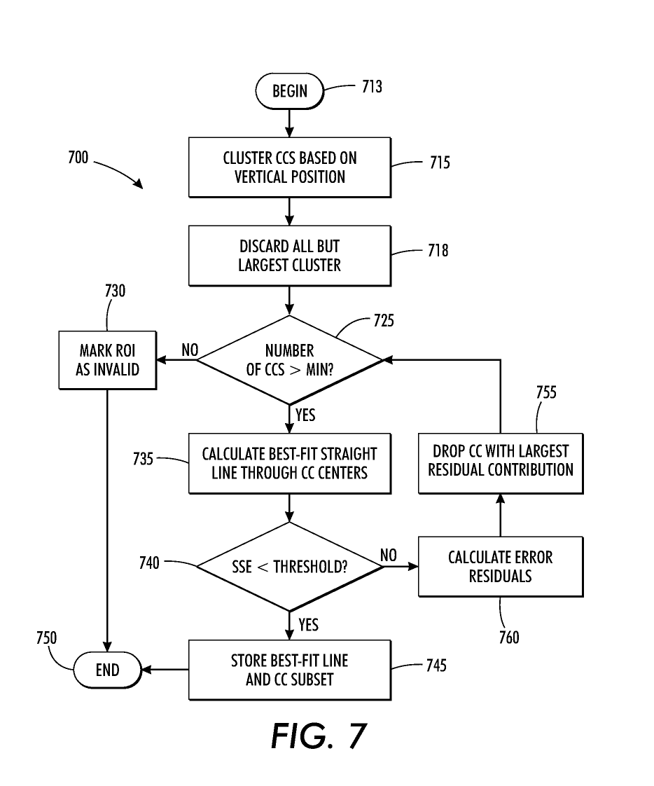

The interface 153, which is preferably a graphical user interface (GUI), can serve to display results, whereupon a user may supply additional inputs or terminate a particular session. In some embodiments, operating system 151 and interface 153 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 151 and interface 153. The software application 154 can include, for example, a license plate tilt adjusting and cropping module 152 for robust tilt adjustment and cropping of a license plate image such as, for example, the license plate image 210 shown in FIG. 3. The license plate tilt adjusting and cropping module 152 can include instructions such as those of methods 600 and 700 discussed herein with respect to FIGS. 6-7.

FIGS. 1-2 are thus intended as examples and not as architectural limitations of the disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms including Macintosh, Unix, Linux, and the like.

FIG. 3 illustrates a block diagram of a license plate tilt adjustment and cropping system 200, in accordance with the disclosed embodiments. Note that in FIGS. 1-17, identical or similar blocks are generally indicated by identical reference numerals. So, for example, image-capturing unit 108 shown in FIG. 3 is similar to the image-processing unit 108 depicted in FIG. 1. System 200 generally includes the image-capturing unit 108, which communicates either directly (e.g., wired connection) or wirelessly with a network 220. The network 220 (e.g., wireless network, the Internet, etc) can communicate directly (e.g., wired connection) or via wireless communications with an image-processing unit 230. The image-processing unit can include, for example, an ALPR unit 235, which generally can include the ALPR unit 235 and a classification unit 230. Units 235 and 240 and their respective components/modules, etc can communicate electronically with one another, or may be implemented in the context of modules (e.g., hardware modules, software modules, etc).

The classification unit can include a valid character module 270 and a suspect character module 272, which are descried in greater detail herein. The ALPR unit 235 can include, for example, a license plate tilt adjustment and cropping module 152, which in turn can include a first stage character segmentation unit 275 and a second stage character segmentation unit 245. The first stage character segmentation unit 275 can include, for example, a tight bounding box module 280 and a vertical projection histogram 285, which in turn can include an initial character boundaries module 290 and local statistical information module 295. The second stage character segmentation unit 245 can include an OCR subsystem or module 250 which can also include a module 255 for generating and determining a confident quote or data indicative of a confident quote. The unit 245 can further include a confidence threshold module 260 for generating and/or determining confidence threshold data (e.g., a threshold). Unit 245 can also include a module 265 for generating and/or determining segmentation errors and/or data indicative segmentation errors.

In general, system 200 can be implemented to enhance the performance of ALPR (Automated License Plate Recognition), which is a special form of OCR (Optical Character Recognition). License plate recognition is a type of technology, mainly software in nature, but which can include hardware aspects. ALPR can enable a computer system to automatically read a registration number (e.g., a license plate number) of a vehicle (e.g., one or more vehicles) from a digital picture. Automatically reading such a registration number means transforming the pixels of a digital image (e.g., image 210 shown in FIG. 3) into an ASCII text of a number plate.

The license plate recognition system 200 thus generally includes the image-capturing unit 108 (e.g., a camera, digital video camera, etc.) for capturing an image of, for example, a vehicle 205 within an effective field of view. The image-capturing unit 108 can be operatively connected to and/or can communicate with the image-processing unit 230 via the network 220. The image-capturing unit 108 may include built-in integrated functions such as, for example, image-processing, data formatting, and data compression functions. Also, the image-capturing unit 108 and/or the image-processing unit 230 can include an imager-positioning function and a range-finding function, and can also include a flash bulb.

The network 220 shown in FIG. 3 may employ any network topology, transmission medium, or network protocol. Network 220 may include connections such as wire, wireless communication links, fiber optic cables, and so forth. Network 220 can also be an Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Thus, an image 210 of a license plate such as license plate 211 captured by the image-capturing unit 108 can be transmitted from the image-capturing unit 108 through network 220 and to the image-processing unit 230.

The image-capturing unit 108 can be, in some embodiments, integrated with the image-processing unit 230. Units 108 and 230 can be employed to continuously monitor traffic within an effective field of view. In a preferred embodiment, the image-capturing unit 108 can be triggered by a sensor (i.e., not shown in FIG. 3), which can detect the presence of a vehicle in a target acquisition zone. The image-processing unit 230 receives a captured image from the image-capturing unit 108 in order to process the image (e.g., image of a license plate). The image-processing unit 230 is preferably a small, handheld computer device or palmtop computer that provides portability and is adapted for easy mounting. The configuration shown in FIG. 1, for example, may serve such a functionality. That is, the data-processing system or apparatus 100 can be implemented as, for example, a handheld computing device, palmtop computer, a laptop computer, etc. The image-capturing unit 108 can capture multiple images (e.g., front and rear license plate images) of, for example, the license plate 211 as the vehicle 205 passes through an observation zone and the image-processing unit 230 processes each image utilizing the license plate tilt adjustment and cropping module 152.

The image-processing unit 230 can be configured to include the license plate tilt adjustment and cropping module 152 that removes any inherent tilt and obtains a vertically cropped license plate image with respect to the originally captured image 210, even for cases of extremely coarse plate localization and large amounts of non-character image content present in the image. The license plate tilt adjustment and cropping module 152 can further include an image-converting capability, which can convert the image (e.g., gray for infrared captures) to a binary image utilizing a binarization approach. Note that such a binarization approach can be, for example, gradient-based binarization depending upon design considerations. The license plate tilt adjustment and cropping module 152 can remove a large amount of blur and multi-scale salt and pepper noise in the original gray and the resulting impacts on the binarized image. The license plate tilt adjustment and cropping module 152 can also be employed to automatically generate an image that is tightly cropped on the plate.

A morphological filtering unit (e.g., second stage character segmentation unit 245) can be employed to remove a long run (horizontal sequences of “on” pixels that exceed a predefined length) within the image and breaks an unwanted connection between characters due to a license plate frame and an image noise. A connected component-analyzing unit (e.g., image-processing unit 230) can identify and screen a CC (Connected component) within the image based on a number of key metrics to remove a most likely candidate character via, for example, the classification unit 240. The candidate characters can be pruned based on a number of key metrics, for example, connected component area, angle of orientation of a connected component blob. The candidate characters can be substantially vertical within the input image to eliminate a large fraction of connected components due to plate frames, artifacts from stickers around the plate, rear emblems on vehicles, and noise from the binarization step.

A line-fit based iterative search can be employed to perform robust tilt removal and vertical cropping of the license plate image to obtain a tight bounding box (e.g., see tight bounding box module 280) with respect to the license plate characters if sufficient candidate characters remain after the search process. Otherwise, the region of interest can be rejected. A line-fit based iterative search can determine a best fit straight line for some subset of the candidate character connected components so that the license plate characters can lie along a straight line path.

A line-fit based iterative search can be automatically employed to fit a straight-line through the connected component center data and calculated a total sum squared error in the fit. Such a line-fit based iterative search can further calculate a residual error for each data point and excludes the connected component with the largest error contribution. If the total sum squared error is larger than a pre-determined threshold, the process can then be repeated until a better set of candidate connected components for which a straight-line fit through their centers can be found or the connected components are not sufficient to continue.

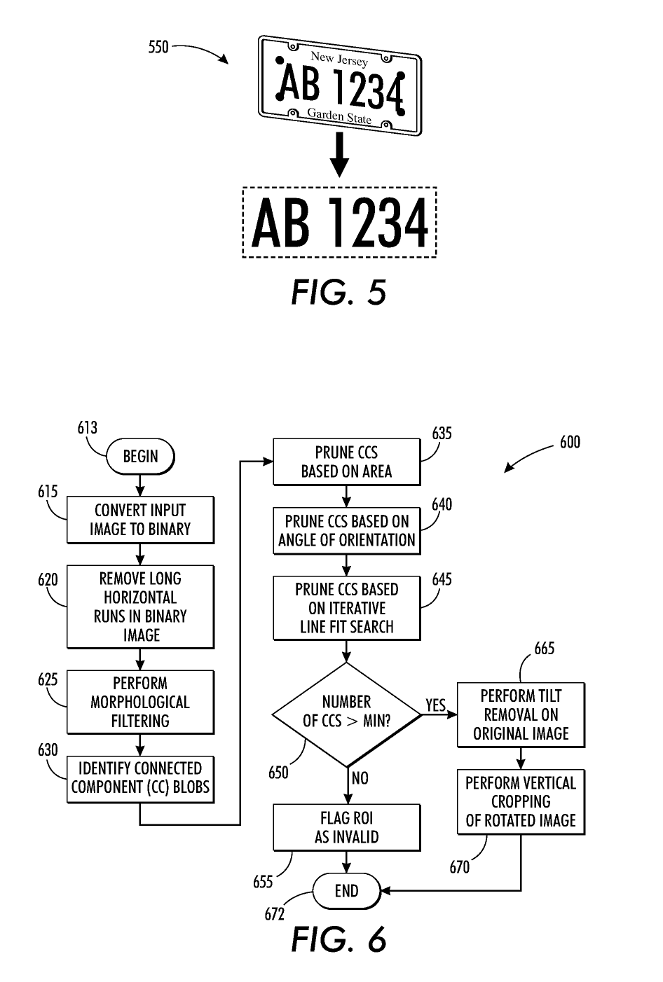

A line-fit based iterative search can be employed to estimate a tilt angle (θ) of the license plate utilizing the straight line fit through their centers if sufficient candidate characters remains. After removing this tilt in the image by rotating by −θ, a median height of the candidate character connected components can be utilized to determine required vertical cropping to obtain a tight bounding box (e.g., see tight bounding box module 280) about the license plate characters. A fixed border allowance can be applied beyond the median height to ensure that characters are not accidentally cropped, even for extreme cases. The result is a properly oriented license plate image that has been vertically cropped, as illustrated in FIG. 5. A subsequent horizontal cropping operation can then produce the desired tight bounding box image for the license plate, as illustrated in FIG. 5.

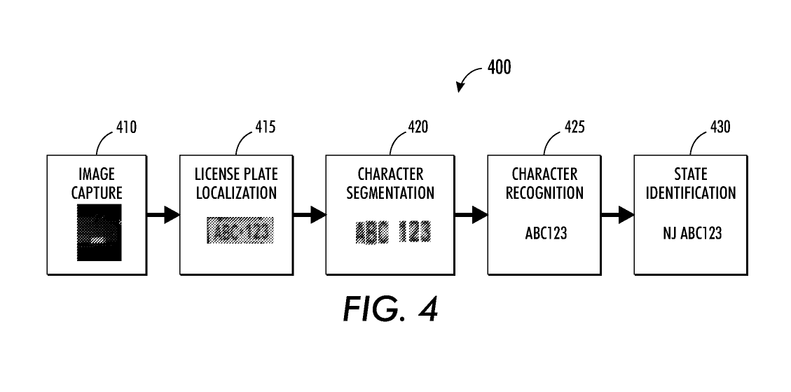

FIG. 4 illustrates a block diagram of an ALPR method 400, in accordance with the disclosed embodiments. The ALPR method 400 can include steps to, for example, locate the license plate 211 from a captured image of the license plate 210 by identifying a sub-region of the vehicle image that contains the license plate 211, as indicated at blocks 410 and 415. Thereafter, as shown at block 420, a character segmentation operation can be implemented. That is, the license plate characters can be segmented by extracting individual character sub-images. Next, as indicated at block 425, a character recognition operation can be implemented. Characters can be recognized and then as shown at block 430, a state identification operation can be performed.

FIG. 5 illustrates a pictorial view 550 of tilt removal and tight bounding box extraction with respect to a license plate image, in accordance with the disclosed embodiments.

FIG. 6 illustrates a high level flow chart of operations illustrating logical operational steps of a line-fit based iterative searching method 600, in accordance with the disclosed embodiments. As indicated at block 613, the process can be initiated. Thereafter, as shown at block 615, an operation can be processed to convert an input image to binary format or data. Next, as shown at block 620, an operation can be implemented to remove horizontal runs in the binary image (or images). Following processing of the operation shown at block 620, a morphological filtering operation can be performed with respect to the image as indicated at block 625. Thereafter, as indicated at block 630, an operation can be performed to identify CC (Connected Component) blobs in the image.

Such CCS (Connected Components) can be pruned based on area, as shown next at block 635. Then, as described at block 640, CCS can be pruned based on an angle of orientation. Thereafter, as depicted at block 645, CCS can be pruned based on an iterative line fit search. Thereafter, as indicated at decision block 650, a test can be performed to determine if CCS>MIN. If the answer is “NO”, then the operation depicted at block 655 is processed (i.e., ROI is flagged as invalid). The process can then terminate, as shown at block 672. Assuming the answer is “YES” in response to the operation performed as shown at block 650, the tilt removal can be performed with respect to the original image (e.g., image 210 shown in FIG. 3). Then, as depicted at block 670, vertical cropping of the rotated image can be performed. The process can then terminate, as indicated at block 672.

FIG. 6 thus illustrates a method 600 for robust tilt adjustment and cropping of one or more images (e.g., images of license plates). An input image can be converted to a binary image (e.g., image 210), as indicted at block 615. The long horizontal runs in the binary image can be removed, as described at block 620. Morphological filtering can be performed and the CC blobs can be identified, as illustrated at blocks 625 and 630.

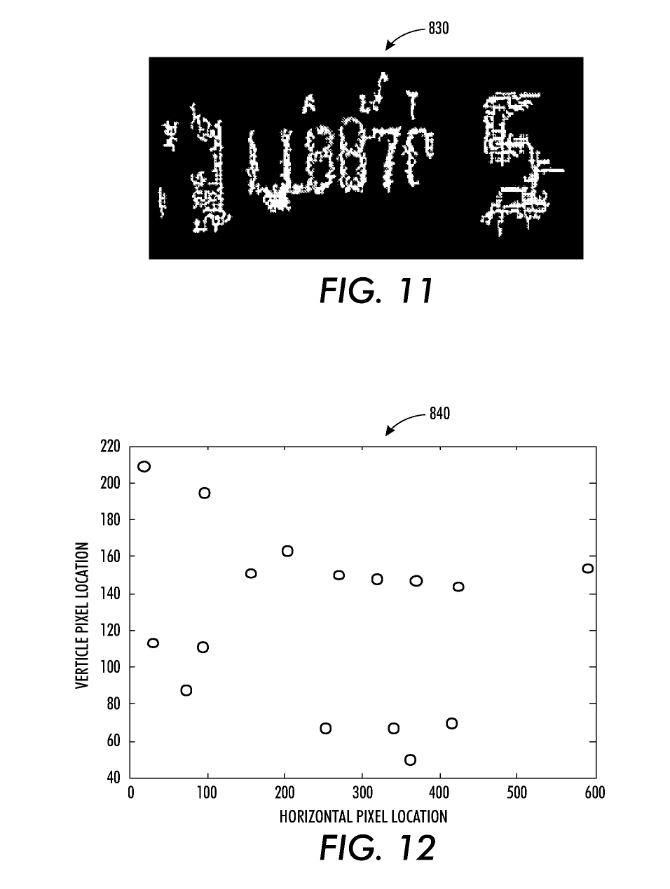

The CC can be pruned based on area, as described at block 635. The CC can be pruned based on angle of orientation and iterative line fit search, as shown at blocks 640 and 645. Screening based on the angle of orientation of the CC blobs can be performed by enforcing the fact that candidate characters are substantially vertical within license plate images. This screening tends to eliminate a large fraction of CCs due to things like plate frames, artifacts from stickers around the plate, rear emblems on vehicles, and noise from the binarization step. Even after performing all of these pruning operations, the set of candidate character CCs often still contain a fair number of irrelevant, unwanted members (non-character CCs) as shown in FIG. 11, where the actual character CCs only represents a fraction of the remaining blobs.

FIG. 7 illustrates a high level flow chart of operations illustrating logical operational steps of a line-fit based iterative searching method 700, in accordance with the disclosed embodiments. As indicated at block 713, the process can be initiated. Thereafter, as shown at block 715, candidate characters CCs can be clustered based on the vertical position. All but the largest cluster can be discarded, as shown at block 718. This additional pruning step relies on the assumption that even with tilt present, the license plate characters can be grouped more closely together (according to their vertical coordinate) than the other artifacts in the image. Next, a determination can be made whether a number of remaining candidate characters CCs is greater than minimum, as described at block 725. If the number of candidate characters CCs is greater than minimum, the best-fit line through the connected component centers can be calculated, as illustrated at block 735.

A determination can then be made whether a SSE (Sum-Squared Error) is less than a threshold, as described at block 740. If the SSE is less than the threshold, the best-fit line and the connected component subset can be stored, as illustrated at block 745. If the SSE is not less than the threshold, error residuals can be calculated, as depicted at block 760. Thereafter, the connected component with the largest residual contribution can be dropped, as described at block 755 and another determination can be made whether a number of candidate characters CCs is greater than minimum, as described at block 725. If the number of candidate characters CCs is not greater than minimum, the ROI can be marked as invalid, as shown at block 730.

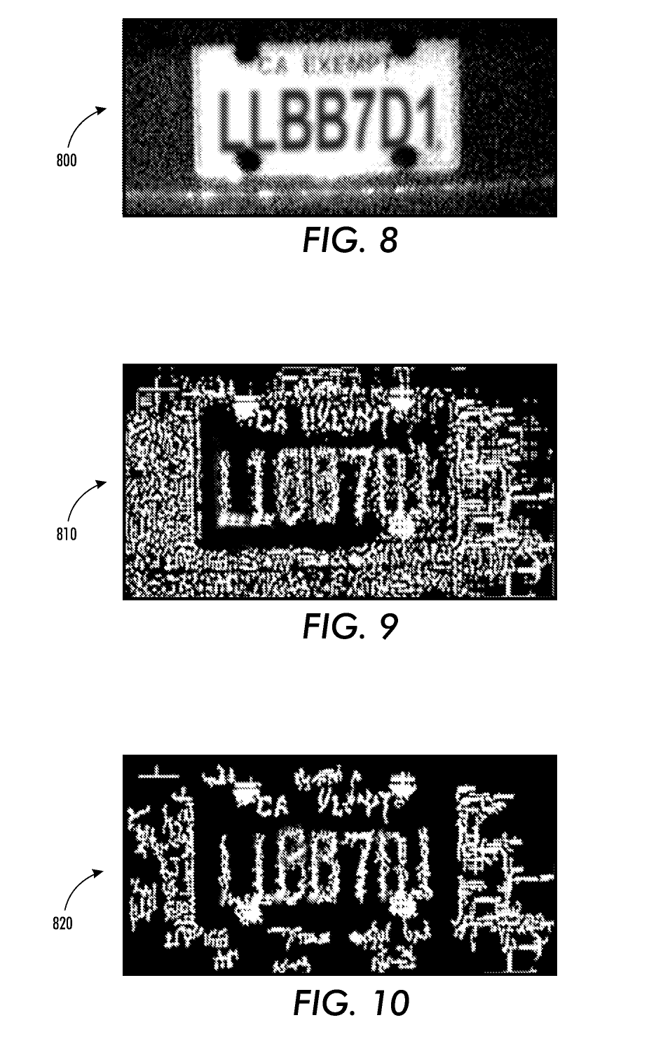

FIGS. 8-9 illustrate an exemplary view of an original grayscale image 800 and a binary image 810 after morphological filtering, in accordance with the disclosed embodiments. Recall that the connected component can be pruned based on area, as described earlier herein with respect to block 635 shown in FIG. 6. The connected component can be pruned based on an angle of orientation and iterative line fit search, as described previously with respect to blocks 640 and 645 in FIG. 6.

FIGS. 10-11 illustrate an exemplary view of the image 820 and 830 screened based on the connected component area and the angle of orientation of the connected component blob, in accordance with the disclosed embodiments. The candidate characters must meet certain minimum and maximum size criteria.

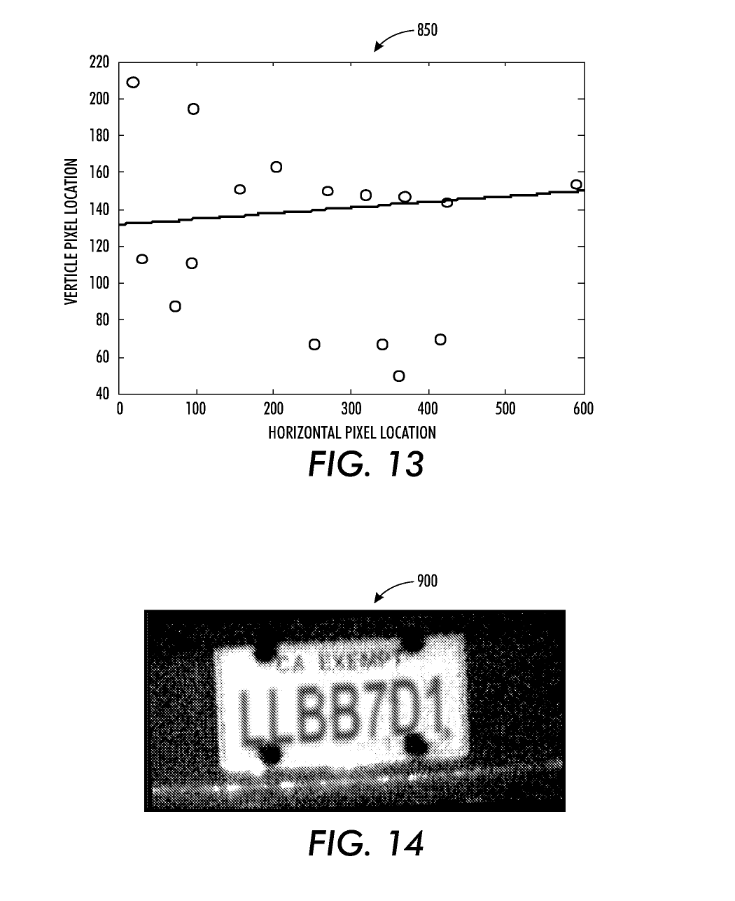

FIGS. 12-13 illustrate respective graphs 840 and 850 depicting a center of connected component after angle screening and a weighted least square line fit, in accordance with the disclosed embodiments. FIG. 14 illustrates an exemplary view of an image 900 after tilt removal based on the weighted least square line fit of the connected component center data, in accordance with the disclosed embodiments. A plot of the center locations for these CCs is depicted in FIG. 12 for reference. The plot 840 clearly indicates the remaining challenge in attempting to isolate the likely characters from the non-character (noise) CCs and to estimate the tilt angle of the license plate within the image. In fact, direct application of a weighted least square technique to the blob center data shown in graph 840 of FIG. 12 can produce the results depicted in FIGS. 13 and 14, where there is clearly a substantial residual tilt in the corrected license plate image. The approach described herein can be employed to remove the substantial residual tilt in the corrected license plate image.

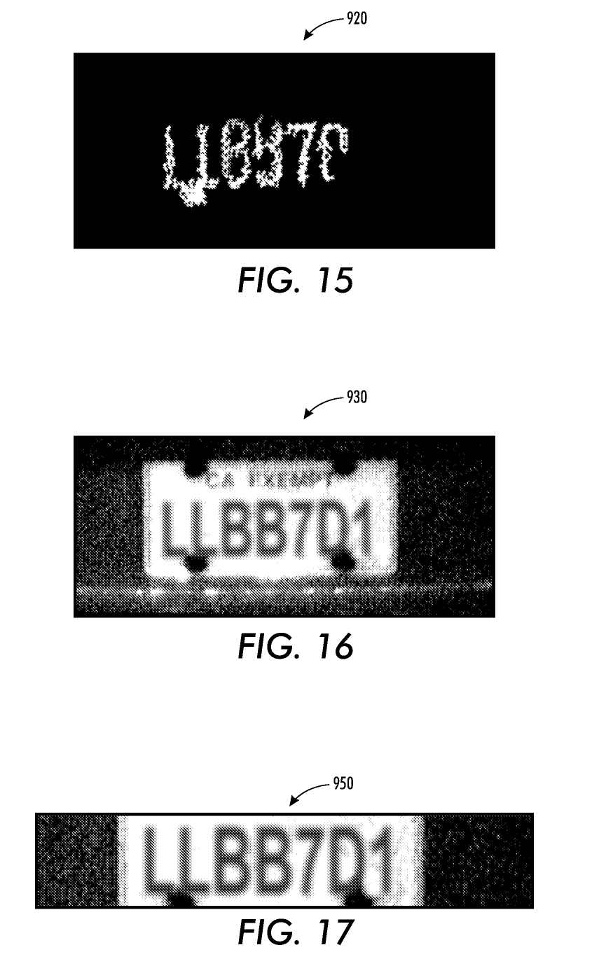

FIG. 15 illustrates an exemplary view of an image 920 after screening CCs by vertical separation and line filing, in accordance with the disclosed embodiments. FIG. 16 illustrates an exemplary view of an ROI image 930 after tilt removal, in accordance with the disclosed embodiments. FIG. 17 illustrates an exemplary view of an image 950 after tilt removal and vertical cropping, in accordance with the disclosed embodiments. The straight line fit through their centers can be employed to estimate the tilt angle θ of the license plate. After removing this tilt in the image by rotating by −θ as shown in FIG. 16, the median height of the candidate character CCs can be utilized to determine the required vertical cropping to obtain a tight bounding box with respect to the license plate characters.

As indicated previously, vertical cropping of the image can be performed, as described at block 670 in FIG. 6. If the number of candidate characters (CCs) is not greater than minimum, the ROI as invalid can be flagged, as shown at block 655 also in FIG. 6. A median filtering, or leverage additional screening of the candidate characters using a priori information (e.g., expected character height ranges) can also be employed. A fixed border allowance beyond the median height can also be applied to ensure that characters are not accidentally cropped, even for extreme cases. The result is a properly oriented license plate image that has been vertically cropped as depicted in the image 950 of FIG. 17. A subsequent horizontal cropping operation can then be performed to generate the desired tight bounding box image for the license plate.

Based on the foregoing, it can be appreciated that a number of embodiments, preferred and alternative, are disclosed herein. In one embodiment, for example, a method can be implemented for tilt adjustment and cropping of license plate images. Such a method can include, for example, converting an image of a vehicle into a binary image, the image of the vehicle including data indicative of a license plate of the vehicle and license plate characters thereof; removing a long run within a binary image and applying a morphological filtering to break an unwanted connection between the license plate characters due to a license plate frame and an image noise; identifying and screening a connected component within the binary image based on a plurality of key metrics to remove all but the most likely candidate character connected components from the binary image; and performing a line-fit based iterative search for a tilt removal and a vertical cropping of the binary image to obtain a tight bounding box with respect to the license plate characters if a sufficient candidate character remains after performing the line-fit based iterative search, thereby removing any inherent tilt and obtaining a vertically cropped license plate image based on the image of the vehicle.

In another embodiment, a step can be implemented for rejecting a region of interest with respect to the image of the vehicle and the data indicative of the license plate of the vehicle and the license plate characters if the sufficient candidate character is not present after performing the line-fit based iterative search. In another embodiment, the step of screening the connected component can further include screening the connected component based on a connected component area. In yet another embodiment, the step of screening the connected component can further include screening the connected component based on an angle of orientation of a connected component blob.

In still another embodiment, the candidate character substantially vertical within the image of the vehicle in order to eliminate a large fraction of connected components due to a plate frame, an artifact from a sticker around the plate, a rear emblem on the vehicle, and a noise from binarization of the image into the binary image. In still other embodiments, a step can be implemented for determining a best fit straight line for a subset of the candidate character and the connected component so that at least one license plate character among the license plate characters lies along a straight line path.

In still another embodiment, the step of performing the line-fit based iterative search can further include the steps of fitting a straight-line through center data of the connected component and thereafter calculating a total sum squared error thereof; calculating a residual error for each data point associated with the center data, if the total sum squared error is larger than a pre-determined threshold; excluding the connected component with respect to a largest error contribution; and repeating the fitting of the straight-line, calculating the residual error, and excluding the component until an enhanced set of candidate connected components for which a straight-line fit through a center is determined.

In another embodiment, a system for tilt adjustment and cropping of license plate images can be implemented. Such a system can include, for example, a processor; a data bus coupled to the processor; and a computer-usable medium embodying computer program code. The computer-usable medium can be coupled to the data bus. The computer program code can include instructions executable by the processor and configured for, for example, converting an image of a vehicle into a binary image, the image of the vehicle including data indicative of a license plate of the vehicle and license plate characters thereof; removing a long run within a binary image and applying a morphological filtering to break an unwanted connection between the license plate characters due to a license plate frame and an image noise; identifying and screening a connected component within the binary image based on a plurality of key metrics to remove all but the most likely candidate character connected components from the binary image; and performing a line-fit based iterative search for a tilt removal and a vertical cropping of the binary image to obtain a tight bounding box with respect to the license plate characters if a sufficient candidate character remains after performing the line-fit based iterative search, thereby removing any inherent tilt and obtaining a vertically cropped license plate image based on the image of the vehicle.

In some embodiments, such instructions can be further configured for rejecting a region of interest with respect to the image of the vehicle and the data indicative of the license plate of the vehicle and the license plate characters if the sufficient candidate character is not present after performing the line-fit based iterative search. In other embodiments, screening the connected component can further include screening the connected component based on a connected component area. In yet other embodiments, screening the connected component can further include screening the connected component based on an angle of orientation of a connected component blob.

In other embodiments, the candidate character can be substantially vertical within the image of the vehicle in order to eliminate a large fraction of connected components due to a plate frame, an artifact from a sticker around the plate, a rear emblem on the vehicle, and a noise from binarization of the image into the binary image. In still other embodiments, such instructions can be further configured for determining a best fit straight line for a subset of the candidate character and the connected component so that at least one license plate character among the license plate characters lies along a straight line path.

In still other embodiments, the aforementioned instructions for performing the line-fit based iterative search can be further configured for fitting a straight-line through center data of the connected component and thereafter calculating a total sum squared error thereof; calculating a residual error for each data point associated with the center data, if the total sum squared error is larger than a pre-determined threshold; excluding the connected component with respect to a largest error contribution; and repeating the fitting of the straight-line, calculating the residual error, and excluding the component until an enhanced set of candidate connected components for which a straight-line fit through a center is determined.

In still another embodiment, a processor-readable medium storing code representing instructions to cause a process to perform a process for tilt adjustment and cropping of license plate images can be implemented. Such code can include code to, for example, convert an image of a vehicle into a binary image, the image of the vehicle including data indicative of a license plate of the vehicle and license plate characters thereof; remove a long run within a binary image and applying a morphological filtering to break an unwanted connection between the license plate characters due to a license plate frame and an image noise; identify and screen a connected component within the binary image based on a plurality of key metrics to remove all but the most likely candidate character connected components from the binary image; and perform a line-fit based iterative search for a tilt removal and a vertical cropping of the binary image to obtain a tight bounding box with respect to the license plate characters if a sufficient candidate character remains after performing the line-fit based iterative search, thereby removing any inherent tilt and obtaining a vertically cropped license plate image based on the image of the vehicle.

In another embodiment, such code can further include code to reject a region of interest with respect to the image of the vehicle and the data indicative of the license plate of the vehicle and the license plate characters if the sufficient candidate character is not present after performing the line-fit based iterative search. In still another embodiment of a process-readable medium, screening the connected component can further include screening the connected component based on a connected component area. In yet another embodiment of a processor-readable medium, screening the connected component can further include screening the connected component based on an angle of orientation of a connected component blob.

In another embodiment of a processor-readable medium, the candidate character can be substantially vertical within the image of the vehicle in order to eliminate a large fraction of connected components due to a plate frame, an artifact from a sticker around the plate, a rear emblem on the vehicle, and a noise from binarization of the image into the binary image. In still another embodiment of a processor-readable medium, the code can further include code to determine a best fit straight line for a subset of the candidate character and the connected component so that at least one license plate character among the license plate characters lies along a straight line path.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A method for tilt adjustment and cropping of license plate images, the method comprising:
converting an image of a vehicle into a binary image, said image of said vehicle including data indicative of a license plate of said vehicle and license plate characters thereof;
removing a long run within a binary image and applying a morphological filtering to break an unwanted connection between said license plate characters due to a license plate frame and an image noise;
identifying and screening a connected component within said binary image based on a plurality of key metrics to remove all but the most likely candidate character connected components from said binary image; and
performing a line-fit based iterative search for a tilt removal and a vertical cropping of said binary image to obtain a tight bounding box with respect to said license plate characters if a sufficient candidate character remains after performing said line-fit based iterative search, thereby removing any inherent tilt and obtaining a vertically cropped license plate image based on said image of said vehicle.

2. The method of claim 1 further comprising rejecting a region of interest with respect to said image of said vehicle and said data indicative of said license plate of said vehicle and said license plate characters if said sufficient candidate character is not present after performing said line-fit based iterative search.

3. The method of claim 1 wherein said screening said connected component further comprises screening said connected component based on a connected component area.

4. The method of claim 1 wherein said screening said connected component further comprises screening said connected component based on an angle of orientation of a connected component blob.

5. The method of claim 1 wherein said candidate character is substantially vertical within said image of said vehicle in order to eliminate a large fraction of connected components due to a plate frame, an artifact from a sticker around said plate, a rear emblem on said vehicle, and a noise from binarization of said image into said binary image.

6. The method of claim 1 further comprising determining a best fit straight line for a subset of said candidate character and said connected component so that at least one license plate character among said license plate characters lies along a straight line path.

7. The method of claim 1 wherein said performing said line-fit based iterative search, further comprises:
fitting a straight-line through center data of said connected component and thereafter calculating a total sum squared error thereof;
calculating a residual error for each data point associated with said center data, if said total sum squared error is larger than a pre-determined threshold;
thereafter excluding said connected component with respect to a largest error contribution; and
repeating said fitting of said straight-line, said calculating said residual error, and said excluding said component until an enhanced set of candidate connected components for which a straight-line fit through a center is determined.

8. A system for tilt adjustment and cropping of license plate images, said system comprising:
a processor;
a data bus coupled to said processor; and
a computer-usable medium embodying computer program code, said computer-usable medium being coupled to said data bus, said computer program code comprising instructions executable by said processor and configured for:
converting an image of a vehicle into a binary image, said image of said vehicle including data indicative of a license plate of said vehicle and license plate characters thereof;
removing a long run within a binary image and applying a morphological filtering to break an unwanted connection between said license plate characters due to a license plate frame and an image noise;
identifying and screening a connected component within said binary image based on a plurality of key metrics to remove all but the most likely candidate character connected components from said binary image; and
performing a line-fit based iterative search for a tilt removal and a vertical cropping of said binary image to obtain a tight bounding box with respect to said license plate characters if a sufficient candidate character remains after performing said line-fit based iterative search, thereby removing any inherent tilt and obtaining a vertically cropped license plate image based on said image of said vehicle.

9. The system of claim 8 wherein said instructions are further configured for rejecting a region of interest with respect to said image of said vehicle and said data indicative of said license plate of said vehicle and said license plate characters if said sufficient candidate character is not present after performing said line-fit based iterative search.

10. The system of claim 8 said screening said connected component further comprises screening said connected component based on a connected component area.

11. The system of claim 8 wherein said screening said connected component further comprises screening said connected component based on an angle of orientation of a connected component blob.

12. The system of claim 8 wherein said candidate character is substantially vertical within said image of said vehicle in order to eliminate a large fraction of connected components due to a plate frame, an artifact from a sticker around said plate, a rear emblem on said vehicle, and a noise from binarization of said image into said binary image.

13. The system of claim 8 wherein said instructions are further configured for determining a best fit straight line for a subset of said candidate character and said connected component so that at least one license plate character among said license plate characters lies along a straight line path.

14. The system of claim 8 said instructions for performing said line-fit based iterative search, are further configured for:
fitting a straight-line through center data of said connected component and thereafter calculating a total sum squared error thereof;
calculating a residual error for each data point associated with said center data if said total sum squared error is larger than a pre-determined threshold;
thereafter excluding said connected component with respect to a largest error contribution; and
repeating said fitting of said straight-line, said calculating said residual error, and said excluding said component until an enhanced set of candidate connected components for which a straight-line fit through a center is determined.

15. A processor-readable medium storing code representing instructions to cause a process to perform a process for tilt adjustment and cropping of license plate images, said code comprising code to:
convert an image of a vehicle into a binary image, said image of said vehicle including data indicative of a license plate of said vehicle and license plate characters thereof;
remove a long run within a binary image and apply a morphological filtering to break an unwanted connection between said license plate characters due to a license plate frame and an image noise;
identify and screen a connected component within said binary image based on a plurality of key metrics to remove all but the most likely candidate character connected components from said binary image; and
perform a line-fit based iterative search for a tilt removal and a vertical cropping of said binary image to obtain a tight bounding box with respect to said license plate characters if a sufficient candidate character remains after performing said line-fit based iterative search, thereby removing any inherent tilt and obtaining a vertically cropped license plate image based on said image of said vehicle.

16. The processor-readable medium of claim 15 wherein said code further comprises code to reject a region of interest with respect to said image of said vehicle and said data indicative of said license plate of said vehicle and said license plate characters if said sufficient candidate character is not present after performing said line-fit based iterative search.

17. The processor-readable medium of claim 15 wherein said screening said connected component further comprises screening said connected component based on a connected component area.

18. The processor-readable medium of claim 15 wherein said screening said connected component further comprises screening said connected component based on an angle of orientation of a connected component blob.

19. The processor-readable medium of claim 15 wherein said candidate character is substantially vertical within said image of said vehicle in order to eliminate a large fraction of connected components due to a plate frame, an artifact from a sticker around said plate, a rear emblem on said vehicle, and a noise from binarization of said image into said binary image.

20. The processor-readable medium of claim 15 wherein said code further comprises code to determine a best fit straight line for a subset of said candidate character and said connected component so that at least one license plate character among said license plate characters lies along a straight line path.
